(19) United States
(12) Patent Application Publication
(10) Pub. No.: US 2006/0176636 A1
(43) Pub. Date: Aug. 10, 2006

(54) Electrical fuse circuits and methods of forming the same

(75) Inventor: Eunsung Seo, Seoul (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 11/347,230

(22) Filed: Feb. 6, 2006

(30) Foreign Application Priority Data
Feb. 7, 2005 (KR) 2005-0011240

(51) Int. Cl. H02H 7/20

(52) U.S. Cl. 361/112

(57) ABSTRACT

An electrical fuse circuit may include at least one contact plug and a fusing select control unit. The at least one contact plug may couple a wiring layer of a semiconductor device to an active region of a transistor device. The fusing select control unit may cause a latch-up phenomenon in response to an applied signal so that selected ones of the at least one contact plugs are fused by over-current due to the latch-up phenomenon.

### PRIORITY STATEMENT

This application claims priority under 35 U.S.C. § 119 to Korean Patent Application No. 10-2005-0011240, filed Feb. 7, 2005 in the Korean Intellectual Property Office (KIPO), the entire contents of which are incorporated herein by reference.

### BACKGROUND

1. Technical Field

Example embodiments of the present invention relate to semiconductor devices, for example, electrical fuses, which may be used in semiconductor memory devices.

2. Discussion of Conventional Art

Conventional semiconductor memory devices may not perform desired functions and/or may be treated as inferior upon failure of a memory cell. With increasing integration of the semiconductor memory devices, it is more likely that a reduced number of memory cells will fail. However, discarding inferior devices may be inefficient in terms of yield.

Conventionally, a redundancy memory cell formed in a semiconductor memory device may be substituted for a defective cell, and may be used to salvage a semiconductor memory device having a defective cell.

For example, a redundancy cell may be substituted for a defective cell by melting an electrical fuse with over-current, burning and cutting an electrical fuse with laser beam, short-circuiting a junction with laser beam or programming an EPROM memory cell accordingly. In these conventional electrical fuses, polysilicon wiring or metal wiring may be used as a fuse material.

Of the above examples, the laser cutting method may be simpler and/or more stable than the others and may allow for facilitated layout. However, a laser beam may not be used to cut the fuse after a package is completed, may require a larger fuse corresponding to a beam size of the laser beam and/or may only be able to cut a single fuse at a time. This may degrade productivity and/or integration of semiconductor memory devices.

The above example in which a junction is short-circuited uses breakdown of a gate oxide film of a MOS transistor. Based on the breakdown of the gate oxide film of the MOS transistor, the gate oxide film may be artificially broken down by applying a higher voltage to the gate when the drain, source, body and gate of the MOS transistor are opened by the gate oxide film. This may result in short-circuiting of the drain, source, body and gate of the MOS transistor. This is known as an anti-fuse manner.

This anti-fuse manner, however, transitions from an open state to a short-circuited state rather than from a short-circuited to an open state, and thus, may not easily maintain resistance due to the breakdown in the gate oxide film constant. This anti-fuse manner may also require a separate external power supply, a higher voltage generator for applying a higher voltage to the gate to program and/or a separate circuit for programming desired transistors without affecting peripheral circuits.

In the above example using over-current, a fuse may be melted or cut by increasing external voltage and/or current instead of laser beam. In these examples, the fuse may be made of metal or polysilicon wiring.

Conventionally, electrical fuses may also be used to adjust operating speed of and/or the voltage for a semiconductor memory device in addition to being used as the above-described defect relief circuit.

FIG. 1 is a circuit diagram of a conventional electrical fuse. As shown, before being cut, a fuse F1 may have a resistance smaller than an opposite resistor R1, and an output signal OUT of the circuit may be at a high state after the output signal OUT is initialized. The output signal OUT may be initialized in response to an initial signal INIT.

After being cut and after the output signal OUT is initialized in response to the initial signal INIT, the resistance of the fuse F1 may be relatively higher than the opposite resistor R1, and a transistor PM2 may be connected to a ground voltage VSS by a transistor TR_P1.

In this example, the gate of a transistor PM1 transitions to a high state, the output signal OUT transitions to a low state, and because the resistance of the fuse F1 is greater than the opposite resistor R1, the circuit of FIG. 1 may be utilized as a defect relief circuit. If the N-type MOS transistor NM1 is turned on in response to a fusing signal, current flows through the N-type MOS transistor NM1. This current may transition the fuse F1 to an opened state. However, because the N-type MOS transistor NM1 has a limited current driving capability, the size of the N-type MOS transistor NM1 and/or an external voltage VDD may need to be increased in order to transition the fuse F1 to an open state.

In this example, an electrical fuse may need an N-type MOS transistor having a larger area, in addition to the fuse. As a result, the circuit may occupy a larger area, which may not be as suitable for higher integration semiconductor memory devices.

FIG. 2 is a cross-sectional view of a conventional electrical fuse using a latch-up phenomenon.

FIG. 2 illustrates a CMOS transistor including a P-type MOS transistor and an N-type MOS transistor, and an equivalent circuit diagram of a parasitic latch-up circuit in the CMOS transistor.

The CMOS transistor may be formed by forming an N-type well n− on a P-type semiconductor substrate p− and sequentially implanting N-type impurities n+ and P-type impurities p+. A layer for forming gate electrodes G1 and G2 is formed on a gate oxide film (not shown).

The latch-up circuit naturally produced in the CMOS transistor process may include bipolar junction transistors QN and QP and may cause a latch-up phenomenon due to over-current. An electrical fuse F2 may be coupled to a voltage application wiring layer for applying various voltages such as a power supply voltage VDD or a ground voltage VSS. The electrical fuse F2 may be adapted to be controlled by over-current caused by the latch-up phenomenon.

The conventional electrical fuse with the latch-up phenomenon of FIG. 2 has been laid out on the voltage application wiring layer; however, this may require a separate and/or additional space and/or area, which may reduce integration of semiconductor memory devices.

### SUMMARY OF THE INVENTION

Example embodiments of the present invention provide electrical fuse circuits for a semiconductor devices, which do not need a separate and/or additional space and/or area for laying out an electrical fuse.

An electrical fuse circuit according to an example embodiment of the present invention may include at least one contact plug and a control unit. The at least one contact plug may couple at least one wiring layer of a semiconductor device to at least one active region of a transistor device. The control unit may select at least one of the at least one contact plugs to be fused in response to an applied signal.

In a method for forming an electrical fuse, according to an example embodiment of the present invention, at least one contact hole may be formed in an insulating layer positioned between at least one wiring layer and at least one active region of a substrate. A contact plug may be formed within each of the at least one contact hole to couple the at least one active region with a corresponding wiring layer. Each contact plug may be adapted to fuse when over-current is present on the corresponding wiring layer. In example embodiments of the present invention, the contact plug may fuse when a latch-up phenomenon occurs.

A contact plug according to an example embodiment of the present invention may couple a wiring layer to an active region formed on a substrate. The contact plug may be formed in a contact hole formed through an insulating layer positioned between the wiring layer and the active region. The contact plug may fuse when over-current is present on the wiring layer.

In example embodiments of the present invention, the wiring layer may be a wiring layer for applying a ground voltage or a power supply voltage, and/or may be a metal layer.

In example embodiments of the present invention, the transistor device may include a first conductive region formed on a portion of the first semiconductor substrate, a first impurity region formed on another portion of the first semiconductor substrate, and the active region is formed within a portion of the first conductive region. The control unit may be connected to a third impurity region, which may be formed within a portion of the first conductive region of the latch-up circuit, and controls the latch-up circuit. At least one contact plug may be formed on the active region and may couple at least one wiring layer to the active region, the at least one contact plug formed on the active region being fused when over-current flows through the circuit.

In example embodiments of the present invention, the first conductive semiconductor substrate may be a P-type semiconductor substrate, the first conductive region may be an N-type region, the first impurity region may be a P-type impurity region and the active region may be an N-type impurity region. The first impurity region may have a higher concentration than the first conductive semiconductor substrate and/or the active region may have a higher concentration than the first conductive region. The second impurity region may be formed of substantially the same material as that of the first impurity region and/or the at least one contact plug formed on the active region may be formed of a different material than the wiring layer and/or the active region.

In example embodiments of the present invention, at least one contact hole may be formed in an insulating layer between the active region and the wiring layer, and the at least one contact plug formed on the active region may be formed within the at least one contact hole.

### BRIEF DESCRIPTION OF THE DRAWINGS

Example embodiments of the present invention will become more apparent to those of ordinary skill in the art by describing in detail the example embodiments illustrated in the attached drawings in which:

FIG. 1 is a circuit diagram of a conventional electrical fuse;

FIG. 2 is a cross-sectional view of a conventional electrical fuse;

FIG. 3 is a plan view of an electrical fuse in a semiconductor device according to an embodiment of the present invention;

FIG. 4 is a cross-sectional view illustrating a vertical-section of an electrical fuse according to an example embodiment of the present invention;

FIG. 5 illustrates a fuse contact plug according to an example embodiment of the present invention;

FIG. 6 is circuit diagram illustrating an electrical fuse according to an example embodiment of the present invention; and

FIG. 7 is a circuit diagram showing an example application of an electrical fuse circuit according to an example embodiment of the present invention.

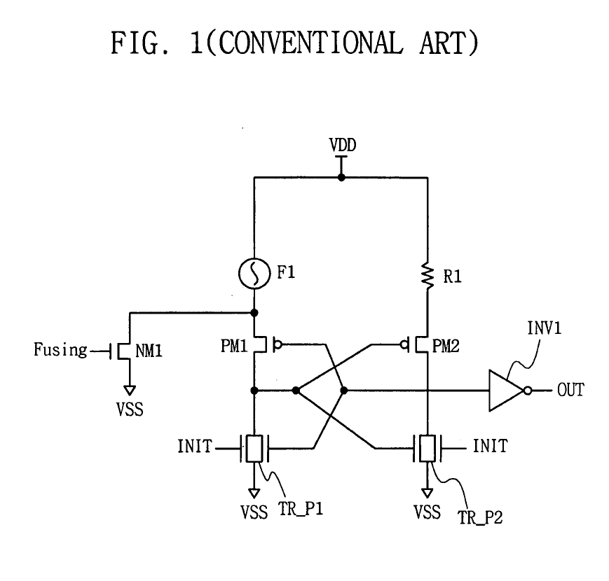

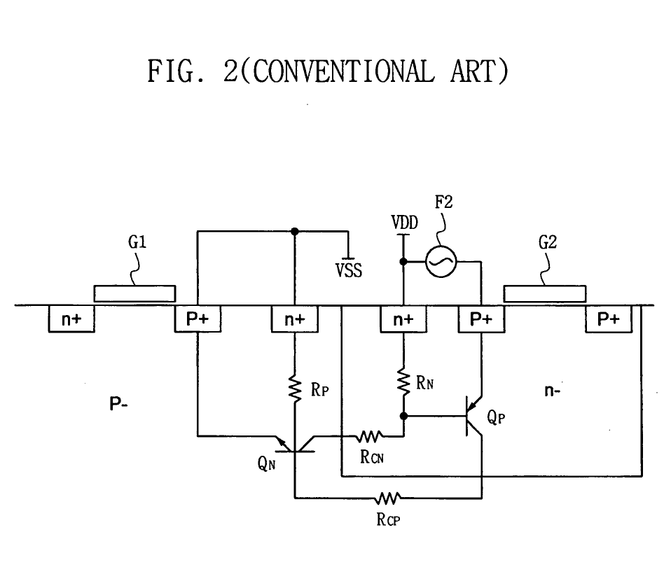

### DETAILED DESCRIPTION OF EXAMPLE EMBODIMENTS OF THE PRESENT INVENTION

Various example embodiments of the present invention will now be described more fully with reference to the accompanying drawings in which some example embodiments of the invention are shown. In the drawings, the thicknesses of layers and regions are exaggerated for clarity.

Detailed illustrative embodiments of the present invention are disclosed herein. However, specific structural and functional details disclosed herein are merely representative for purposes of describing example embodiments of the present invention. This invention may, however, may be embodied in many alternate forms and should not be construed as limited to only the embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the invention to the particular forms disclosed, but on the contrary, example embodiments of the invention are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the FIGS. For example, two FIGS. shown in succession may in fact be executed substantially concurrently or may sometimes be executed in the reverse order, depending upon the functionality/acts involved.

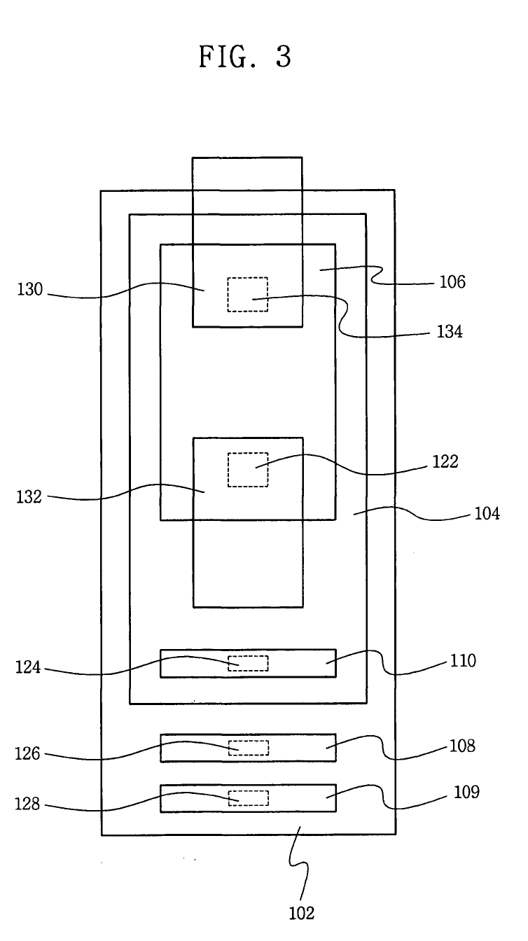

FIG. 3 is a plan view of an electrical fuse in a semiconductor device according to an example embodiment of the present invention. As shown, the electrical fuse of FIG. 3 may comprise a latch-up circuit including a conductive region 104 and impurity regions 106 and 108. The conductive region 104 and the impurity region 108 may be formed on a semiconductor substrate 102 (e.g., a conductivity-type or conductive semiconductor substrate), and the impurity region 106 may be formed on the conductive region 104. The conductive region 104 may be, for example, a P-type conductive region and the semiconductor substrate 102 may be, for example, a P-type semiconductor substrate. The impurity region 108 may be, for example, an N-type impurity region.

The electrical fuse of FIG. 3 may also include voltage application wiring layers 130 and 132 coupled to the impurity region 106 via contacts 122 and 134. The voltage application wiring layers 130 and 132 may supply power to the latch-up circuit.

Each of the contacts 122 and 134 may include a fuse contact plug formed on the impurity region 106. The fuse contact plug may open when over-current flows through the latch-up circuit.

A fusing select control unit (not shown in FIG. 3) may be connected to an impurity region 110. The impurity region 110 may be formed on or within the conductive region 104. The fusing select control circuit may control the latch-up circuit.

As noted above, the semiconductor substrate 102 may be a P-type semiconductor substrate, the conductive region 104 may be an N-type region, and the impurity region 108 may be a P-type impurity region. In one or more example embodiments of the present invention, the impurity region 108 may have a higher concentration than the semiconductor substrate 102.

The impurity region 106 may be an N-type impurity region and may have a higher concentration than the conductive region 104. The impurity region 110 may be a region formed of the same, or substantially the same, material as the impurity region 108. For example, the impurity region 110 may be a P-type impurity region.

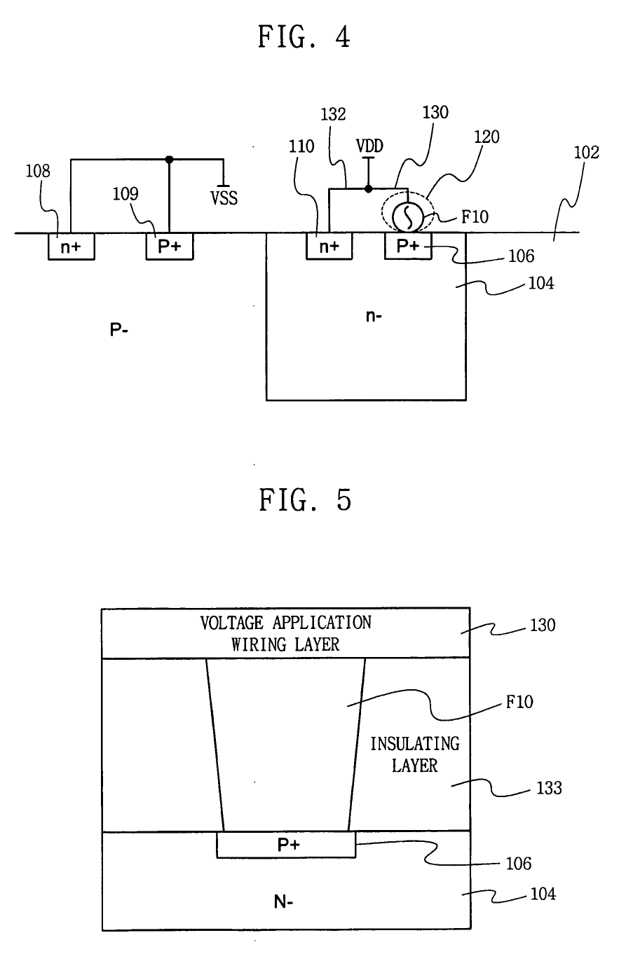

FIG. 4 is a cross-sectional view of an electrical fuse according to an example embodiment of the present invention. As shown, the impurity region 108 may be formed on or within at least a portion of the semiconductor substrate 102 and the impurity region 106 may be formed in the conductive region 104, which may result in the formation of a transistor circuit (e.g., a CMOS transistor circuit) having a structure in which a latch-up phenomenon may occur due to an NPNP or PNPN type junctions may be formed.

A latch-up phenomenon refers to a conduction of a parasitic NPNP or PNPN junction within a semiconductor memory device (e.g., a CMOS chip or any other semiconductor memory device), for example, when a voltage is supplied to the semiconductor memory device. This parasitic NPNP or PNPN junction may lead to a Silicon Controlled Rectifier (SCR) (thyristor) operation in which over-current of several hundreds or more mA flows through an integrated circuit of a semiconductor memory device, and may damage the semiconductor memory device.

As shown in FIG. 4, electrical fuses, according to example embodiments of the present invention, may include the voltage application wiring layers 130 and 132 coupled to the impurity regions 106 and 110 via contacts 122 and 134, respectively. The voltage application wiring layers may supply power (e.g., a power supply voltage) to the latch-up circuit. Each of the contacts 122 and 134 may include a fuse contact plug F10 formed on the impurity region 106 and adapted to open when over-current flows through the latch-up circuit. The fuse according to example embodiments of the present invention may further include a fusing select control unit coupled to an impurity region 110. The impurity region 110 may be formed in the conductive region 104 of the latch-up circuit, and may control the latch-up circuit.

FIG. 5 is a vertical-sectional view illustrating a fuse contact plug according to an example embodiment of the present invention. As shown, fuse contact plug F10 may couple the voltage application wiring layer 130 to the impurity region 106 and may function as a fuse, which may fuse or open (e.g., has higher resistance) when over-current flows through the latch-up circuit. The fuse contact plug F10 may be formed of a different material than that of the voltage application wiring layer 130 and/or the impurity region 106. In one or more example embodiments of the present invention, a contact hole for coupling the impurity region 106 and the voltage application wiring layer 130 may be formed in an insulating layer 133 between the impurity region 106 and the voltage application wiring layer 130 in FIG. 4, and a fuse contact plug F10 may be formed in the contact hole.

The voltage application wiring layer 130 may be a wiring layer for supplying a ground voltage VSS or a power supply voltage VDD. The voltage application wiring layer 130 may be, for example, formed of a conductive material, such as, any metal or metal alloy.

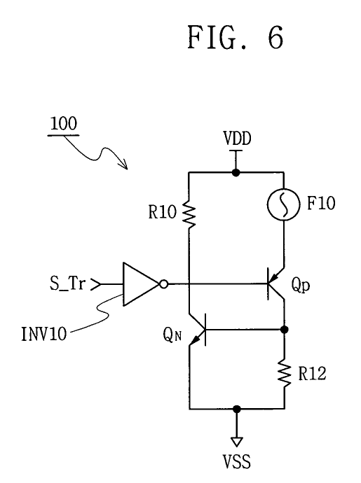

FIG. 6 is a circuit diagram illustrating an electrical fuse according to an example embodiment of the present invention. As shown, a fusing or trigger signal S_Tr may be input to a base of a transistor (e.g., a bipolar junction transistor) QP via an inverter INV10 by a fusing select control unit. In operation, the fuse contact plug F10 may be opened, for example, when over-current flows due to the fusing signal S_Tr.

Referring to FIGS. 3 to 6, an electrical fuse circuit for a semiconductor device fabricated using a method (e.g., CMOS process technology) according to an example embodiment of the present invention may include an electrical fuse unit and/or a fusing select control unit. The electrical fuse unit may be formed by coupling a portion of contact plugs between a voltage application wiring layer of the semiconductor device and an active region of the transistor device. The fusing select control unit may cause the latch-up phenomenon in response to an applied signal so that at least one of the contact plugs may be fused by over-current resulting from the latch-up phenomenon. The at least one of the contact plugs may be the fuse contact plugs F10.

In example embodiments of the present invention, voltage application wiring layers may be wiring layers for applying a ground voltage VSS or a power supply voltage VDD. The voltage application wiring layers may be formed using conductive materials, such as, metal.

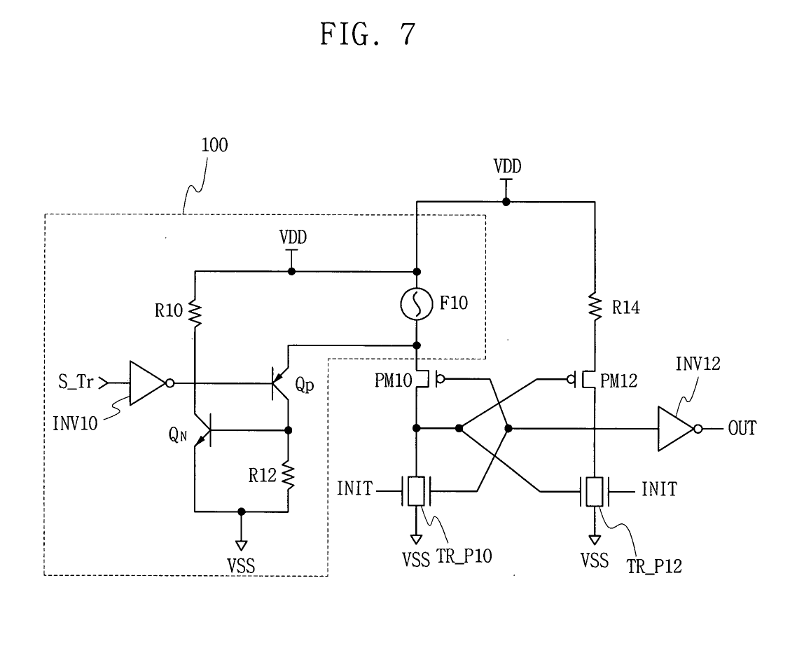

FIG. 7 is a circuit diagram illustrating an example application of an electrical fuse according to an example embodiment of the present invention. As shown, when the fusing signal S_Tr is input to the transistor (e.g., bipolar junction transistor) QP, a fuse contact plug F10 may have a greater resistance than that of a resistor R14. For example, since the fuse contact plug F10 has smaller resistance than that of the opposite resistor R14 before being fused, an output signal OUT may transition to a higher state after being initialized in response to the initial signal INIT.

Since the fuse contact plug F10, after being fused, has relatively greater resistance than that of the opposite resistor R10, the output signal OUT may transition to a lower state after being initialized in response to the initial signal INIT. In example embodiments of the present invention, since the resistance of the fuse F10 may be greater than that of the opposite resistor R1, which may be partially open, the circuit may function as an electrical fuse. The electrical fuse circuit may be utilized, for example, in a defect relief circuit of a semiconductor memory device to substitute for defective cells. For example, the fusing signal S_Tr may be a signal associated with an address signal indicating a defective cell.

In another example embodiment of the present invention, the electrical fuse circuit may be used when the fuse contact plug F10 is opened (e.g., completely opened) by over-current due to latch-up. Alternatively, the electrical fuse circuit may be used to adjust (e.g., finely adjust) an operating speed and/or voltage of a semiconductor device.

In a method of forming an electrical fuse in a semiconductor device (e.g., using CMOS process technology) according to an example embodiment of the present invention, a portion of contact plugs coupled between a power supply or ground voltage application wiring layer for the semiconductor device and an active region of a device fabricated by the CMOS process technology may constitute an electrical fuse.

In another method of forming an electrical fuse according to an example embodiment of the present invention, at least one contact hole may be formed in an insulating layer positioned between at least one wiring layer and at least one conductive region of a semiconductor substrate. A contact plug may then be formed within each of the at least one contact hole to couple an impurity region formed on each of the at least one conductive region with a corresponding wiring layer.

Referring to FIG. 3, in one or more example embodiments of the present invention, the impurity region 106, impurity region 110 and the like may be formed by forming an N-type well 104 on the P-type semiconductor substrate 102 and by ion-implanting P-type and N-type impurities, which may produce a transistor (e.g., a CMOS transistor). The impurity regions may be active regions of the device.

The voltage application wiring layers 130 and 132 may be formed over the active region to supply the power supply voltage to the impurity region 106, the impurity region 110, etc. The contact plug (e.g., F10 of FIG. 5), may be formed to couple between the voltage application wiring layers 130 and 132 and the active region. For example, the contact plug (e.g., F10 of FIG. 5) may be an electrical plug, which may be electrically fused when a latch-up phenomenon occurs.

While example embodiments of the present invention have been described in connection with the example in which a lower portion is the active region of the device and the upper portion is the voltage application wiring layer, various applications are possible in a structure having an upper layer and a lower layer forming a vertical structure and contacts for coupling between them. For example, both materials which may be coupled by the contact plug may be different from each other. In another example, if the one is an active region, the other may be polysilicon, if the one is polysilicon, the other may be a metal, and if the one is a metal, the other may be a different metal.

As described above, a conventional electrical fuse may have a two-dimensional arrangement (e.g., since it may be formed in an area departing from an active region of the device) while electrical fuses according to example embodiments of the present invention may be in a three-dimensional arrangement (e.g., since it may utilize the active region of the device and the contact plugs of the voltage application wiring layer, the positions thereof being different in a vertical view and being identical or close to each other in a horizontal view) by forming at least one contact plug as the electrical fuse. Example embodiments of the present invention may increase integration of semiconductor memory devices.

One or more example embodiments of the present invention may reduce a need for a separate area for laying out electrical fuses and/or a need for larger sized MOS transistor fusing.

Example embodiments of the present invention have been described with reference to the example embodiments of the present invention shown in the drawings. However, it is to be understood that the scope of the present invention is not limited to the disclosed example embodiments. On the contrary, the scope of the present invention is intended to include various modifications and alternative arrangements within the capabilities of persons skilled in the art using presently known or future technologies and equivalents. The scope of the claims, therefore, should be accorded the broadest interpretation so as to encompass all such modifications and similar arrangements.

What is claimed is:

1. An electrical fuse circuit comprising:
at least one contact plug coupling at least one wiring layer of a semiconductor device to at least one active region of a transistor device; and
a control unit for selecting at least one of the at least one contact plugs to be fused in response to an applied signal.

2. The circuit according to claim 1, wherein the wiring layer is a wiring layer for applying a ground voltage or a power supply voltage.

3. The circuit according to claim 1, wherein the wiring layer is a metal layer.

4. The circuit according to claim 1, wherein
the transistor device includes,
a first conductive region formed on a portion of the first semiconductor substrate, a first impurity region formed on another portion of the first semiconductor substrate, and the active region is formed within a portion of the first conductive region,
the control unit is connected to a second impurity region, which is formed within a portion of the first conductive region of the latch-up circuit, and controls the latch-up circuit, and
at least one of the contact plugs is formed on the active region and couples at least one wiring layer to the active region, the at least one contact plug formed on the active region being fused when over-current flows through the circuit.

5. The circuit according to claim 4, wherein the first conductive semiconductor substrate is a P-type semiconductor substrate, the first conductive region is an N-type region, the first impurity region is a P-type impurity region and the active region is an N-type impurity region.

6. The according to claim 5, wherein the first impurity region has a higher concentration than the first conductive semiconductor substrate.

7. The circuit according to claim 5, wherein the active region has a higher concentration than the first conductive region.

8. The circuit according to claim 4, wherein the second impurity region is formed of substantially the same material as the first impurity region.

9. The circuit according to claim 8, wherein the at least one contact plug formed on the active region is formed of a different material than the wiring layer.

10. The circuit according to claim 9, wherein the at least one contact plug is formed of a different material than the active region.

11. The circuit according to claim 4, wherein at least one contact hole is formed in an insulating layer between the active region and the wiring layer, and the at least one contact plug formed on the active region is formed within the at least one contact hole.

12. The circuit according to claim 4, wherein the wiring layer is a wiring layer for applying a ground voltage or a power supply voltage.

13. The circuit according to claim 4, wherein the wiring layer is a metal layer.

14. A method for forming an electrical fuse, the method comprising:
forming at least one contact hole in an insulating layer positioned between at least one wiring layer and at least one active region of a substrate; and
forming a contact plug within each of the at least one contact hole to couple the at least one active region with a corresponding wiring layer; wherein
each contact plug is adapted to fuse when over-current is present on the corresponding wiring layer.

15. The method according to claim 14, wherein the contact plug fuses when a latch-up phenomenon occurs.

16. A contact plug coupling a wiring layer to an active region formed on a substrate, the contact plug being formed in a contact hole formed through an insulating layer positioned between the wiring layer and the active region; wherein
the contact plug fuses when over-current is present on the wiring layer.

17. The contact plug of claim 16, wherein the contact plug is formed of a different material than the active region.

18. The contact plug of claim 16, wherein the wiring layer is a wiring layer for applying a ground voltage or a power supply voltage to a semiconductor device.

19. An electrical fuse including the contact plug of claim 16.

20. An electrical fuse formed using the method of claim 14.
